(19) United States
(12) Patent Application Publication
(10) Pub. No.: US 2021/0108688 A1
(43) Pub. Date: Apr. 15, 2021

(54) BRAKE CALIPER UNIT

(71) Applicant: Adolf KOCHSIEK, Leopoldshöhe (DE)

(72) Inventor: Adolf KOCHSIEK, Leopoldshöhe (DE)

(21) Appl. No.: 17/047,902

(22) PCT Filed: Apr. 9, 2019
(86) PCT No.: PCT/EP2019/058978

§ 371 Date: Oct. 15, 2020

(30) Foreign Application Priority Data
Apr. 17, 2018 (EP) 18167668.5

(51) Int. Cl. F16D 55/226; B60T 1/06; F16D 65/00; F16D 65/18

(52) U.S. Cl. CPC F16D 55/226; B60T 1/065; F16D 2055/0016; F16D 65/183; F16D 65/0068

(57) ABSTRACT

The disclosure relates to a brake caliper unit for disc brakes, comprising a carrier forming a caliper, a pneumatically operated piston/cylinder assembly, and a brake lining, wherein a piston and a cylinder have a non-circular cross section and are designed as a tandem piston assembly.

### CROSS-REFERENCE TO RELATED APPLICATIONS

This application is a U.S. National Phase Application under 35 U.S.C. 371 of International Application No. PCT/EP2019/058978 filed on Apr. 9, 2019, which claims the benefit of European Patent Application No. 18167668.5, filed on Apr. 17, 2018. The entire disclosures of the above applications are incorporated herein by reference.

### FIELD

The disclosure relates to brake caliper unit for disc brakes.

### BACKGROUND

This section provides background information related to the present disclosure which is not necessarily prior art.

Disc brake systems are well known in prior art and are widely used. These are rotating discs which are mounted on axles and shafts and which pass through a slot in a brake caliper unit. Pistons are arranged inside the brake caliper unit which are operable by a pressure medium. At a pressure increase, the pistons exert pressure on a brake lining which is usually plate-shaped and positioned between the piston and the disc. The advancing piston presses the brake lining against the disc, whereby the disc is decelerated. Systems are known in which the pressure is applied on one side, for which reason a brake lining is arranged in a floating manner opposite a brake disc and so that it can be moved parallel to the friction surface of the brake disc. Brake linings which are positioned on both sides of the disk are thus guided onto the brake disc. Also known are brake caliper units which are operated on two sides and in which pressure is applied to pistons on both sides of the brake disc so that brake linings are advanced on both sides.

Increasing attempts are being made to develop pneumatic brake systems which can meet the mechanical requirements. The main reason therefor is the fact that the brake fluids used in the hydraulic brake systems are hygroscopic, i.e. become aged through water absorption, whereby their non-compression properties are considerably weakened. These brake fluids must be frequently exchanged, which pollutes the environment and causes high costs for operators.

The problem with pneumatic systems is the required pressurization. Conventional brake pistons are round-cylindrical units which exert pressure on plate-shaped brake lining units. The piston surface available for pneumatic pressure is small compared to the force required so that the pressure must be set extremely high in this case. This causes high operating costs and high costs for the layout of the pneumatic system, the lines, sealings and the like.

In general, pneumatic pressures cannot be as high as hydraulic pressures because air can be compressed more. The generation of high pneumatic pressures is uneconomical.

### SUMMARY

This section provides a general summary of the disclosure, and is not a comprehensive disclosure of its full scope or all of its features.

Based on the above-described prior art, the object of the disclosure is to further improve a brake caliper unit of the generic type in such a way that it is suitable for use in pneumatic brake systems.

For the technical solution of this object, the disclosure proposes a brake caliper unit with the features of patent claim 1. Further advantages and features will become apparent from the sub-claims.

According to the disclosure it is provided that the piston and the cylinder of a piston/cylinder assembly have a non-round cross section, i.e. they are not circular, but can have a non-circular cross-sectional shape. An advantageous proposal of the disclosure provides for an elliptical shape. Other polygonal shapes or a cycloid are also generally suitable. This makes it possible to design the piston surface, which is exposed to a pressure medium, correspondingly large.

According to the disclosure it is further proposed that the piston/cylinder assembly be designed as a tandem piston assembly. In the professional world, a tandem piston is understood to be an assembly or arrangement, at least in terms of the present disclosure, where pressure is applied to piston units arranged one behind the other and where the pressure applied to one of the pistons correspondingly increases the pressure on the subsequent piston. Similar to tandem cylinders of known design, two individual pressure pistons are arranged one behind the other. A primary piston is actuated by the tappet while pressure is simultaneously applied. In addition, pressure is also applied to the piston moving the tappet. The term “tandem brake cylinder” is analogously used in terms of the present disclosure. Basically, this is a series connection of pressure piston units to the effect that the resulting pressure is increased. This increase can exceed 75%.

By the inventive measures, i.e. increasing the effective piston surface and providing a tandem design, a pressure is generated by a pneumatic system which is sufficient to exert sufficient force on the brake linings.

The required installation space and thus the total weight are not increased compared to existing systems.

According to the disclosure, at least two piston/cylinder assemblies are arranged side by side. A parallel arrangement of several piston-cylinder assemblies is also possible in order to increase the friction surface by means of a corresponding number of brake linings.

In the manner according to the disclosure, the brake pistons are designed for a floating arrangement on a wheel assembly. This means that the brake piston can move parallel to the friction surface of the brake disc relative to the brake disc. In this manner, the brake disc is always automatically centered in the brake caliper slot.

In the manner according to the disclosure, the carrier can have an accommodation chamber for the piston/cylinder assembly. The piston/cylinder assembly has a pot-shaped piston with a non-round cross section and serves to advance the brake lining.

In a design according to the disclosure, the tandem configuration is formed by two pot-shaped piston units guided in one another, wherein the inner piston unit forms a cylinder chamber for a piston and is penetrated by the piston rod connected to the piston. This piston rod is in turn connected to the outer pot-shaped piston receiving the inner pot-shaped piston in its interior. The outer pot-shaped piston unit thus forms a cylinder chamber for the inner pot-shaped unit, which thus forms another piston.

With the present disclosure there are proposed highly effective measures for a brake caliper unit which is suitable to perform the build-up of a sufficient pressure during operation with pneumatic media, i.e. with compressed air.

### DRAWINGS

The drawings described herein are for illustrative purposes only of selected embodiments and not all possible implementations, and are not intended to limit the scope of the present disclosure.

Further advantages and features of the disclosure will become apparent from the following description with reference to the attached drawings, wherein it is shown by:

FIG. 1 a lateral view of one embodiment of a brake caliper unit according to the disclosure;

FIG. 2 a section along line A-A according to FIG. 1K;

FIG. 3 a partial sectional plan view of the brake caliper unit according to FIG. 1;

FIG. 4 a partial sectional exploded view of the piston/cylinder assembly according to the disclosure.

Identical elements in the Figures are marked with identical reference signs.

### DETAILED DESCRIPTION

Example embodiments will now be described more fully with reference to the accompanying drawings.

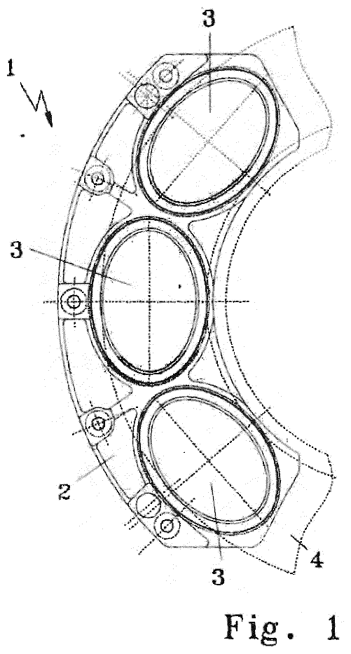

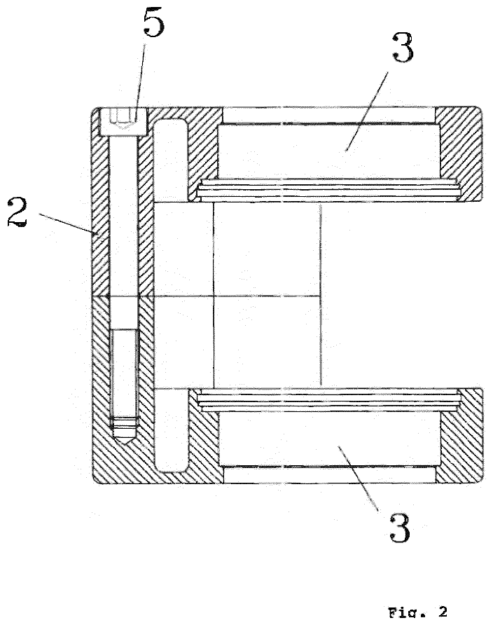

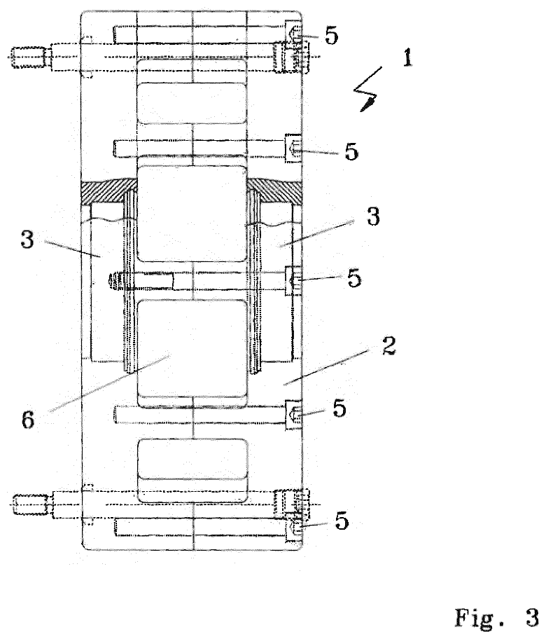

The FIGS. 1 to 3 show the general structure of a brake caliper unit 1 that consists of a carrier 2 in which accommodation chambers 3 for brake pistons are formed. In the known manner, the brake caliper unit 1 runs over a brake disc 4, which is only indicated in FIG. 1 and which passes through between two opposite brake piston accommodation chambers 3, as shown by the FIGS. 2 and 3. In the illustrated embodiment, the carrier 2 is of two-part design, and the two halves are connected by screws 5.

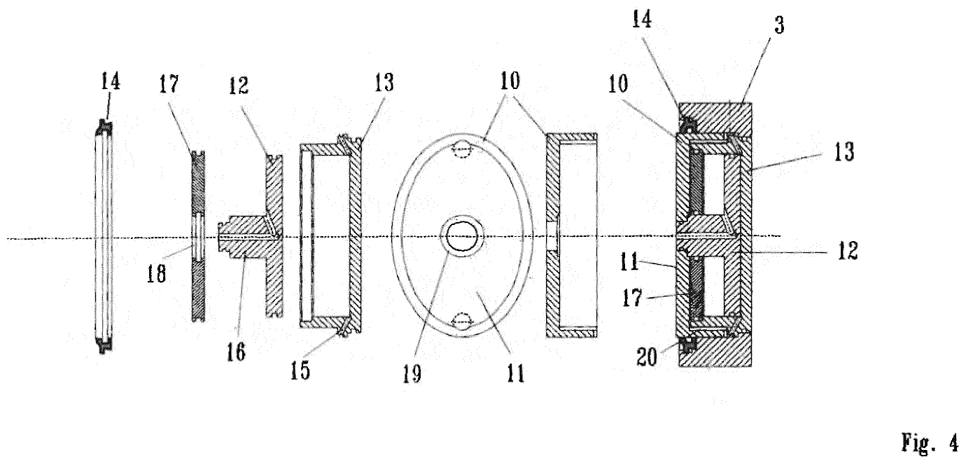

FIG. 4 shows the structure of a brake piston unit according to the disclosure, which is arranged in an accommodation chamber 3 in the carrier.

With its outer pressure surface 11, the element called brake piston 10 presses a brake lining (not shown) against the disc. For this purpose, the brake piston 10 is moved by a piston 12, which is guided in a cylinder 13 and which is connected via its piston rod 16 to the brake piston 10 at the connection 19. Pressure medium lines 15 are formed in the cylinder 13 to bring the pressure medium to the region in the interior of the cylinder 13 and under the piston 12. Thus the piston 12 is advanced and also pushes the brake piston 10 forward. The piston rod 16 penetrates through the cylinder head plate 17, which has an opening 18 for this purpose. The cylinder head plate 17 is arranged on the cylinder 13 in a manner closing the cylinder. If the piston 12 is advanced in the cylinder due to the effect of the pressure medium, the brake piston 10 is also advanced via the piston rod 16 that is fixed in the connection 18 of the brake piston 10. This creates a further space between the cylinder head plate 17 and the interior of the brake piston 10. Additional pressure medium is fed into this resulting gap via a pressure medium line 20 and generates an additional pressure at this point so that brake piston 10 can exert an additional force. The effective piston surfaces add up so that a lower pressure is required for the same braking force.

In the illustrated embodiment, three elliptical accommodation chambers 3 for the brake piston units are formed in the carrier. The elliptical contour allows a large piston surface and thus a large power transmission while simultaneously preventing rotation. The individual elements of the piston unit can be turned non-round, i.e. elliptical, so that the manufacture of the individual brake piston units and the accommodation spaces in the caliper is very simple and cheap.

The embodiments described only serve the purpose of explanation and are not limiting.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are to be regarded as a departure from the disclosure, and all such modifications are intended to be included within the scope of the disclosure.

1. A brake caliper unit for disc brakes, comprising a carrier forming a caliper, a pneumatically operated piston/cylinder assembly, and a brake lining,
wherein
a piston and cylinder have a non-circular cross section and are designed as a tandem piston assembly.

2. The brake caliper unit according to claim 1, wherein the piston and the corresponding cylinder have an elliptical cross section.

3. The brake caliper unit according to claim 1, wherein at least two piston/cylinder assemblies are arranged side by side.

4. The brake caliper unit according to claim 1, wherein the same is designed for a floating arrangement on a wheel assembly.

5. The brake caliper unit according to claim 1, wherein the carrier includes an accommodation chamber for the piston/cylinder assembly.

6. The brake caliper unit according to claim 1, wherein the piston for advancing the brake lining is designed as a pot-shaped piston.

7. The brake caliper unit according to claim 1, wherein the piston/cylinder unit comprises two pot-shaped piston units which are guided in one another, wherein the interior forms a cylinder chamber for a piston and is penetrated by a piston rod and forms a further piston on its outer surface so that the outer pot-shaped piston unit forms in its interior a cylinder chamber for this further piston.
